(19) United States
(12) Patent Application Publication
(10) Pub. No.: US 2005/0271942 A1
(43) Pub. Date: Dec. 8, 2005

(54) Alkaline dry battery and method of producing the same

(76) Inventors: Hidekatsu Izumi, Osaka (JP); Michiko Fujiwara, Osaka (JP); Yasuo Mukai, Osaka (JP); Shigeto Noya, Osaka (JP)

Correspondence Address: MCDERMOTT WILL & EMERY LLP, 600 13TH STREET, N.W., WASHINGTON, DC, 20005-3096, US

(21) Appl. No.: 11/146,286

(22) Filed: Jun. 7, 2005

(30) Foreign Application Priority Data
Jun. 8, 2004 (JP) 2004-169957

(51) Int. Cl. H01M 4/52; H01M 4/50; H01M 2/08; H01M 10/04

(52) U.S. Cl. 429/223; 429/224; 429/185; 29/623.2

(57) ABSTRACT

The alkaline dry battery of the present invention has a battery case accommodating a positive electrode including manganese dioxide and nickel oxyhydroxide, a negative electrode including zinc, and an alkaline electrolyte; a sealing plate for sealing an opening of the battery case; and a sealing member disposed in between the battery case and the sealing plate. And the alkaline dry battery has a sealant layer including a blown asphalt and polybutene in between the battery case and the sealing member.

### BACKGROUND OF THE INVENTION

The present invention relates to an alkaline dry battery, especially to a sealant applied in between a battery case and a sealing member of the alkaline dry battery.

So far, various considerations on the sealant have been made to improve a resistance to electrolyte leakage. For example, in Japanese Laid-Open Patent Publication Nos. Sho 62-139246 and Hei 10-50318, asphalt, polybutene, chlorosulfonated polyethylene, polyamide, and combinations thereof have been proposed as the sealant, for example.

Although manganese dioxide has been used conventionally for a positive electrode of an alkaline dry battery, there has been considered to further use nickel oxyhydroxide for the positive electrode, in order to improve discharge characteristics at a large current. However, in a metal battery case which also functions as a positive electrode current collector, a positive electrode potential is constantly applied. When the nickel oxyhydroxide which has a higher potential and oxidizing effect compared with manganese dioxide is used, since the sealant applied to the sealing part of the battery case is exposed to a higher potential than the manganese dioxide, the sealant becomes prone to deteriorate due to the oxidization.

Also, under heat cycle conditions, the battery case and sealing member expand and shrink with repeated rapid changes in temperature. Therefore, when a sealant which solidifies after its application and drying is used, a gap may be created between the sealant applied part, and the battery case and the sealing member. Further, when the sealant is a rubber-made, it tends to deteriorate under a low temperature.

Therefore, in the alkaline battery in which a mixture of manganese dioxide and nickel oxyhydroxide is used for a positive electrode, a further improvement for the resistance to electrolyte leakage was necessary.

Thus, in order to solve the above problems, the present invention aims to provide an alkaline dry battery which has an excellent resistance to leakage when the positive electrode includes manganese dioxide and nickel oxyhydroxide.

### BRIEF SUMMARY OF THE INVENTION

An alkaline dry battery of the present invention comprises:

a positive electrode including manganese dioxide and nickel oxyhydroxide;

a negative electrode including zinc;

a separator disposed in between the positive and negative electrodes;

an alkaline electrolyte;

a battery case accommodating the positive and negative electrodes, the separator, and the alkaline electrolyte;

a sealing plate for sealing an opening of the battery case; and

a sealing member disposed in between the battery case and the sealing plate,

wherein, a sealant layer including a blown asphalt, and polybutene is provided in between the battery case and the sealing member, and
a weight ratio of the nickel oxyhydroxide relative to a total of the manganese dioxide and the nickel oxyhydroxide in the positive electrode is 0.2 to 0.8.

In the sealant layer, it is preferable that a weight ratio of the polybutene relative to a total of the blown asphalt and the polybutene is 0.2 to 0.5.

Additionally, a method of producing an alkaline dry battery of the present invention includes the steps of:

(1) accommodating a positive electrode including manganese dioxide and nickel oxyhydroxide, and a separator in a battery case,

(2) applying a sealant including a blown asphalt, polybutene, and an organic solvent to a part of the battery case where a sealing member is in close contact,

(3) forming a sealant layer by drying the applied sealant,

(4) accommodating a negative electrode including an alkaline electrolyte and zinc in the battery case, and

(5) sealing an opening of the battery case with a sealing plate and the sealing member interposing the sealant layer.

In the sealant of the above mentioned step (2), it is preferable that a weight ratio of a total of the blown asphalt and the polybutene relative to a total of the blown asphalt, the polybutene, and the organic solvent is 0.3 to 0.7.

It is preferable that a viscosity of the sealant is 50 to 350 mPa.s.

According to the present invention, an alkaline dry battery which has an excellent resistance to electrolyte leakage can be provided even though the nickel oxyhydroxide is included in the positive electrode, by using a blown asphalt which has an excellent resistance to oxidation and a polybutene which is excellent in tight sealing. Especially, the present invention significantly improves the resistance to electrolyte leakage in a battery which is used under rigorous conditions such as heat cycle conditions.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view of a partial cross section of an alkaline dry battery in Example of the present invention.

### DETAILED DESCRIPTION OF THE INVENTION

The present invention relates to an alkaline dry battery comprising:

a battery case accommodating a positive electrode including manganese dioxide and nickel oxyhydroxide, a negative electrode including zinc, a separator disposed in between the positive and negative electrodes, and an alkaline electrolyte;

a sealing plate for sealing an opening of the battery case; and

a sealing member disposed in between the battery case and the sealing plate.

And the alkaline dry battery comprises a sealant layer including a blown asphalt and polybutene in between the battery case and the sealing member: and a weight ratio of a nickel oxyhydroxide weight D relative to a total weight of a manganese dioxide weight C and the nickel oxyhydroxide weight D (hereinafter referred to as D/(C+D)) satisfies 0.2 to 0.8.

The blown asphalt has an excellent resistance to oxidation, and has properties to maintain viscosity without solidification even after an application. Also, the polybutene has excellent tight-sealing characteristics and low temperature properties. The sealant layer including both of these has a combination of these characteristics and properties. Therefore, a battery with excellent resistance to leakage can be obtained, even when nickel oxyhydroxide having strong oxidizing effect is used for a positive electrode. Also, since this sealant layer has an appropriate viscosity and excellent tight-sealing characteristics, the resistance to leakage under rigorous conditions, especially heat cycle conditions, can be drastically improved.

When D/(C+D) is below 0.2, large current discharge characteristics becomes insufficient due to a small amount of the nickel oxyhydroxide. On the other hand, when D/(C+D) is over 0.8., the sealant layer becomes prone to deteriorate by oxidation, due to a large amount of the nickel oxyhydroxide.

It is preferable that a weight ratio of a polybutene weight B relative to a total of a blown asphalt weight A and the polybutene weight B (hereinafter referred to as B/(A+B)) satisfies 0.2 to 0.5. When B/(A+B) is below 0.2, it becomes prone to deteriorate at a low temperature, due to a small amount of the polybutene. On the other hand, when B/(A+B) is over 0.5, the sealant layer becomes prone to deteriorate by oxidation, due to a small amount of the blown asphalt.

The above sealant layer can be formed to seal the alkaline dry battery by the following method, for example.

A positive electrode including manganese dioxide and nickel oxyhydroxide, and a separator is accommodated in a battery case (step 1). Subsequently, a sealant including a blown asphalt, polybutene, and an organic solvent is applied to a part of the battery case where a sealing member is to be closely contacted (step 2).

It is preferable that a weight ratio of a total weight of a blown asphalt weight A and a polybutene weight B relative to a total weight of the blown asphalt weight A, the polybutene weight B, and an organic solvent weight E (hereinafter referred to as (A+B)/(A+B+E)) satisfies 0.3 to 0.7. When (A+B)/(A+B+E) is below 0.3, viscosity declines based on an increased amount of the organic solvent, and the sealant becomes prone to flow out to the part other than the part where it was applied. On the other hand, when (A+B)/(A+B+E) is over 0.7, viscosity increases based on a decreased amount of the organic solvent, and the sealant tends to cause uneven application. For the organic solvent, petroleum benzine, toluene, xylene, and the like are used.

It is preferable that the viscosity of the sealant is 50 to 350 Pa.s. When the viscosity is within such range, the sealant does not flow out to the part other than the part where the sealant was applied, and uneven application does not occur easily.

Next, a sealant layer is formed by drying the applied sealant (step 3). Subsequently, a negative electrode including an alkaline electrolyte and zinc is accommodated in the battery case (step 4). And an opening of the battery case is sealed by a sealing plate and a sealing member interposing the sealant layer (step 5).

The examples of the present invention are described in detail in the following.

### EXAMPLE 1

(1) Preparation of Sealant

A mixture of 100 parts by weight of a blown asphalt (BLOWN ASPHALT 10 manufactured by COSMO OIL SALES CORPORATION) and 33 parts by weight of polybutene (NISSEKI POLYBUTENE HV-100 manufactured by NIPPON PETROCHEMICALS COMPANY) was dissolved in 100 parts by weight of xylene as an organic solvent to obtain a sealant.

(2) Manufacture of Positive Electrode Material Mixture

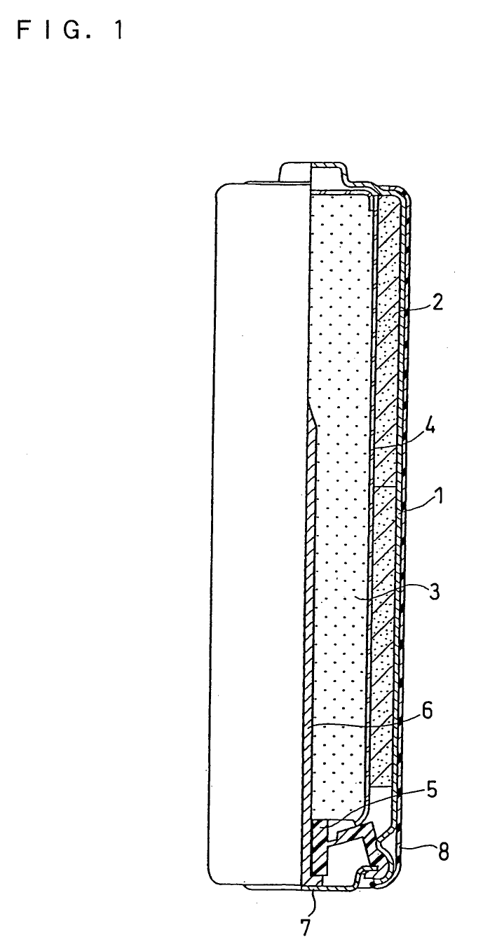

Manganese dioxide, nickel oxyhydroxide, and graphite were mixed in a weight ratio of 50:50:5. Then, the obtained mixture was mixed with 40 wt % sodium hydroxide aqueous solution by a weight ratio of 100:1. After sufficiently stirred, the mixture was subjected to compressing molding to become flakes. Then, the flakes of the positive electrode material mixture were pulverized into granules, followed by classifying with a sieve. Of the classified granules, those having 10 to 100 mesh were pressure molded into a hollow cylindrical shape to give pellets of the positive electrode material mixture. Two pieces of pellets of the positive electrode material mixture were inserted into a bottomed cylindrical battery case 1 having one opening (ref. FIG. 1), and then remolded by means of a compressing jig so as to be placed in intimate contact with the inner wall of the battery case 1.

(3) Manufacture of Gel Negative Electrode

Sodium polyacrylate as a gelling agent, 40 wt % sodium hydroxide aqueous solution as an alkaline electrolyte, and zinc powder as a negative electrode active material were mixed by a weight ratio of 1:33:66, to obtain a gel negative electrode.

(4) Assembly of Cylindrical Alkaline Dry Battery

An AA alkaline dry battery (LR6) with a structure shown in FIG. 1 was assembled by the following procedures. FIG. 1 is a front view of a cylindrical alkaline dry battery partially in cross section.

A bottomed cylindrical separator 4 was disposed in a center of the positive electrode material mixture 2 having close contact with the inner wall of the above battery case 1, and a predetermined amount of an alkaline electrolyte was poured inside the separator 4. After an elapse of a predetermined time, the gel negative electrode 3 obtained above was filled inside the separator 4. As the separator 4, a non-woven fabric made mainly of polyvinylalcohol fibers and rayon fibers was used.

Subsequently, a negative electrode current collector 6 was inserted in the center of the gel negative electrode 3. Herein, the negative electrode current collector 6 was integrated with a sealing member 5 made of resin and a bottom plate (sealing plate) 7 serving as a negative electrode terminal. At this time, the sealant obtained above was applied to a part of the battery case 1 where the sealing member 5 is in close contact. Then, the opening end of the battery case 1 was crimped to the periphery of the bottom plate 7, with the end of the sealing member 5 disposed therebetween, to seal the opening of the battery case 1. Afterwards, the part where the sealant was applied was dried to form a sealant layer. Finally, the outer surface of the battery case 1 was covered with an outer jacket label 8, thereby fabricating an alkaline dry battery.

### COMPARATIVE EXAMPLE 1

A sealant was obtained by dissolving 100 parts by weight of chlorosulfonated polyethylene in 67 parts by weight of xylene. An alkaline battery was prepared in the same manner as in Example 1 except that this sealant was used.

### COMPARATIVE EXAMPLE 2

A sealant was obtained by dissolving 100 parts by weight of chlorosulfonated polyethylene and 33 parts by weight of polybutene in 100 parts by weight of xylene. An alkaline dry battery was prepared in the same manner as in Example 1 except that this sealant was used.

### COMPARATIVE EXAMPLE 3

A sealant was obtained by dissolving 100 parts by weight of a straight asphalt and 33 parts by weight of polybutene in 100 parts by weight of xylene. An alkaline dry battery was prepared in the same manner as in Example 1 except that this sealant was used.

[Evaluation]

Alkaline dry batteries of Example 1 and Comparative Examples 1 to 3 were produced, 100 pieces for each example. Climate-temperature cycle test was conducted based on JIS C8514 for each battery. As for the testing conditions, the steps (A)-(D) shown below were repeated 10 times.

(A) A temperature was increased from 20° C. to 70° C. in 30 minutes, and then the temperature of 70° C. was kept for 4 hours.

(B) The temperature was decreased to 20° C. in 30 minutes, and then the temperature of 20° C. was kept for 2 hours.

(C) The temperature was decreased to −20° C. in 30 minutes, and then the temperature of −20° C. was kept for 4 hours.

(D) The temperature was increased to 20° C. in 30 minutes, and then the temperature of 20° C. was kept for 2 hours.

Subsequently, the battery was stood still at room temperature for 7 days, and the number of the battery which showed leakage was checked. The results are shown in Table 1.

TABLE 1

| | Elapsed Days After Climate - | | | | | | | |
|---|---|---|---|---|---|---|---|---|
| | Temperature Cycle Test | | | | | | | |
| | 0 | 1 | 2 | 3 | 4 | 5 | 6 | 7 |
| Example 1 | 0 | 0 | 0 | 0 | 0 | 0 | 0 | 0 |
| Comparative | 0 | 5 | 10 | 14 | 17 | 19 | 19 | 19 |
| Example 1 | | | | | | | | |
| Comparative | 0 | 0 | 6 | 11 | 15 | 17 | 18 | 18 |
| Example 2 | | | | | | | | |
| Comparative | 0 | 0 | 4 | 8 | 11 | 13 | 14 | 14 |
| Example 3 | | | | | | | | |

No battery showed the leakage even after elapsing 7 days in Example 1, although some batteries in Comparative Examples 1 to 3 showed leakage. Based on this, it was revealed that the alkaline dry batteries of Example 1 of the present invention have an excellent resistance to leakage.

### EXAMPLES 2 TO 6

A weight ratio of a polybutene weight B relative to a total weight of a blown asphalt weight A and the polybutene weight B, i.e., B/(A+B), was changed variously to satisfy the values shown in Table 2. Then, 100 parts by weight of a mixture of the blown asphalt and the polybutene was dissolved in 100 parts by weight of xylene to obtain a sealant. Alkaline dry batteries were produced in the same manner as in Example 1 except that this sealant was used, and subjected to a climate-temperature cycle test. Subsequently, the battery was stood still at room temperature for 30 days, and the number of the battery which showed leakage was checked. The results are shown in Table 2.

TABLE 2

| | | Elapsed Days After Climate - | | | | | | | | | |
|---|---|---|---|---|---|---|---|---|---|---|---|
| | | Temperature Cycle Test | | | | | | | | | |
| | B/(A + B) | 0 | 1 | 2 | 3 | 4 | 5 | 6 | 7 | 15 | 30 |
| Example 2 | 0.10 | 0 | 0 | 0 | 0 | 0 | 0 | 0 | 0 | 3 | 10 |
| Example 3 | 0.20 | 0 | 0 | 0 | 0 | 0 | 0 | 0 | 0 | 0 | 0 |
| Example 4 | 0.35 | 0 | 0 | 0 | 0 | 0 | 0 | 0 | 0 | 0 | 0 |
| Example 5 | 0.50 | 0 | 0 | 0 | 0 | 0 | 0 | 0 | 0 | 0 | 0 |
| Example 6 | 0.60 | 0 | 0 | 0 | 0 | 0 | 0 | 0 | 0 | 5 | 14 |

No battery in Examples 2 to 6 showed the leakage until the seventh day after the cycle test. When B/(A+B) was 0.1, the sealant layer deteriorated while in low temperatures and some batteries showed the leakage from the fifteenth day after the cycle test, due to a small amount of the polybutene. Also, when B/(A+B) was 0.6, the sealant layer deteriorated by oxidation, and some batteries showed the leakage from the fifteenth day after the cycle test, due to a small amount of the blown asphalt. On the other hand, when B/(A+B) was 0.2 to 0.5, no battery showed the leakage, and an excellent resistance to leakage was obtained, even 30 days were elapsed after the cycle test.

### EXAMPLES 7 TO 9 AND COMPARATIVE EXAMPLES 4 TO 5

A weight ratio of a nickel oxyhydroxide weight D relative to a total weight of a manganese dioxide weight C and the nickel oxyhydroxide weight D, i.e., D/(C+D), was changed variously to satisfy the values shown in Table 3 . Then, a positive electrode material mixture was produced in the same manner as in Example 1 except that 100 parts by weight of a mixture of the manganese dioxide and the nickel oxyhydroxide, and 5 parts by weight of graphite were mixed. Alkaline dry batteries were produced in the same manner as in Example 1 except that this positive electrode material mixture was used, and subjected to a climate-temperature cycle test. Subsequently, the battery was stood still at room temperature for 7 days, and the number of the battery which showed leakage was checked. The results are shown in Table 3.

TABLE 3

| | | Elapsed Days After Climate - | | | | | | | |
|---|---|---|---|---|---|---|---|---|---|
| | | Temperature Cycle Test | | | | | | | |
| | D/(C + D) | 0 | 1 | 2 | 3 | 4 | 5 | 6 | 7 |
| Comparative | 0.1 | 0 | 0 | 0 | 0 | 0 | 0 | 0 | 0 |
| Example 4 | | | | | | | | | |
| Example 7 | 0.2 | 0 | 0 | 0 | 0 | 0 | 0 | 0 | 0 |
| Example 8 | 0.5 | 0 | 0 | 0 | 0 | 0 | 0 | 0 | 0 |
| Example 9 | 0.8 | 0 | 0 | 0 | 0 | 0 | 0 | 0 | 0 |
| Comparative | 0.9 | 9 | 19 | 27 | 33 | 37 | 39 | 39 | 39 |
| Example 5 | | | | | | | | | |

When D/(C+D) was 0.1, discharge characteristics under a heavy load were declined due to a low amount of the nickel oxyhydroxide, although no battery showed the leakage. Also, when D/(C+D) was 0.9, the sealant layer deteriorated by oxidation, and some batteries showed the leakage, due to a large amount of the nickel oxyhydroxide. On the other hand, when D/(C+D) was 0.2 to 0.8, no battery showed the leakage, and an excellent resistance to leakage was obtained, even 7 days were elapsed after the cycle test.

### EXAMPLES 10 TO 14

A sealant was obtained in the same manner as in Example 1, except that a weight ratio of a total of a blown asphalt weight A and a polybutene weight B relative to a total weight of the blown asphalt weight A, the polybutene weight B, and a xylene weight E, i.e., (A+B)/(A+B+E), was changed variously to satisfy the values shown in Table 4. At this time, the blown asphalt and the polybutene were mixed to satisfy the weight ratio of 70:30. Alkaline dry batteries were produced in the same manner as in Example 1 except that this sealant was used, and subjected to a climate-temperature cycle test. Subsequently, the battery was stood still at room temperature for 30 days, and the number of the battery which showed leakage was checked. The results are shown in Table 4.

TABLE 4

| | (A + B)/ | Elapsed Days After Climate - | | | | | | | | | |
|---|---|---|---|---|---|---|---|---|---|---|---|
| | (A + B + | Temperature Cycle Test | | | | | | | | | |
| | E) | 0 | 1 | 2 | 3 | 4 | 5 | 6 | 7 | 15 | 30 |
| Example 10 | 0.2 | 0 | 0 | 0 | 0 | 0 | 0 | 0 | 0 | 4 | 15 |
| Example 11 | 0.3 | 0 | 0 | 0 | 0 | 0 | 0 | 0 | 0 | 0 | 0 |
| Example 12 | 0.5 | 0 | 0 | 0 | 0 | 0 | 0 | 0 | 0 | 0 | 0 |
| Example 13 | 0.7 | 0 | 0 | 0 | 0 | 0 | 0 | 0 | 0 | 0 | 0 |
| Example 14 | 0.8 | 0 | 0 | 0 | 0 | 0 | 0 | 0 | 0 | 5 | 21 |

No battery in Examples 10 to 14 showed the leakage until the seventh days after the cycle test. When (A+B)/(A+B+E) was 0.2, some batteries showed the leakage from fifteenth day after the cycle test, due to insufficient sealing properties based on low amounts of the blown asphalt and polybutene. Also, when (A+B)/(A+B+E) was 0.8, some batteries showed the leakage from the fifteenth day after the cycle test, due to insufficient sealing properties based on uneven applications of the sealant from a small amount of the xylene. On the other hand, when (A+B)/(A+B+E) was 0.3 to 0.7, no battery showed the leakage, and an excellent resistance to leakage was obtained, even 30 days were elapsed after the cycle test.

### EXAMPLE 15

A sealant was obtained in the same manner as in Example 1, except that amounts of xylene were changed variously so that a viscosity of the sealant to be obtained satisfies the values shown in Table 5. The viscosities of each sealant was measured by rotational viscometer method with a viscometer (Viscotester VT-04F manufactured by RION Co., Ltd) at a temperature of 20° C.

Then, the sealant was applied to an opening end of a battery case, to evaluate whether uneven application occurred or not, and whether the applied sealant was too runny to stay or not. The results are shown in Table 5.

TABLE 5

| | Viscosity (mPa · s) | | | | | |
|---|---|---|---|---|---|---|
| | 30 | 50 | 150 | 250 | 350 | 400 |
| Uneven Application | NO | NO | NO | NO | NO | YES |
| Excessive Runniness | YES | NO | NO | NO | NO | NO |

When the viscosity was 30 mPa.s, the applied sealant run out because of high fluidity. Also, when the viscosity was 400 mPa.s, the applied sealant became uneven because of low fluidity. On the other hand, when the viscosity was 50 to 350 mPa.s, the applied sealant showed no run out and uneven application, and an excellent sealant layer was obtained.

From the above, it can be concluded that the sealant used in an alkaline dry battery of the present invention is applicable to an alkaline dry battery including nickel oxyhydroxide in positive electrode, based on its resistance to oxidation.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline dry battery comprising:
a positive electrode including manganese dioxide and nickel oxyhydroxide;
a negative electrode including zinc;
a separator disposed in between said positive electrode and said negative electrode;
an alkaline electrolyte;
a battery case accommodating said positive electrode, said negative electrode, said separator, and said alkaline electrolyte;
a sealing plate for sealing an opening of said battery case; and
a sealing member disposed in between said battery case and said sealing plate;
wherein a sealant layer including a blown asphalt and polybutene is provided in between said battery case and said sealing member; and
a weight ratio of said nickel oxyhydroxide relative to a total weight of said manganese dioxide and said nickel oxyhydroxide in said positive electrode is 0.2 to 0.8.

2. The alkaline dry battery in accordance with claim 1, wherein a weight ratio of said polybutene relative to a total weight of said blown asphalt and said polybutene in said sealant layer is 0.2 to 0.5.

3. A method of producing an alkaline dry battery comprising the steps of:
(1) accommodating a positive electrode including manganese dioxide and nickel oxyhydroxide, and a separator in a battery case,
(2) applying a sealant including a blown asphalt, polybutene, and an organic solvent to a part of said battery case where a sealing member is in close contact,
(3) forming a sealant layer by drying said sealant applied,
(4) accommodating a negative electrode including an alkaline electrolyte and zinc in said battery case, and
(5) sealing an opening of said battery case with a sealing plate and said sealing member interposing said sealant layer.

4. The method of producing the alkaline dry battery in accordance with claim 3, wherein in said sealant of said step (2), a weight ratio of a total of said blown asphalt and said polybutene relative to a total of said blown asphalt, said polybutene, and said organic solvent is 0.3 to 0.7.

5. The method of producing the alkaline dry battery in accordance with claim 3, wherein a viscosity of said sealant is 50 to 350 mPa.s.
